(19) United States
(12) Patent Application Publication
(10) Pub. No.: US 2007/0056443 A1
(43) Pub. Date: Mar. 15, 2007

(54) Self-flushing electrostatic seperator

(75) Inventor: Stephan Ahlborn, Senden (DE)

Correspondence Address: GREENBLUM & BERNSTEIN, P.L.C., 1950 ROLAND CLARKE PLACE, RESTON, VA, 20191, US

(73) Assignee: HENGST GmbH & Co. KG, Muenster (DE)

(21) Appl. No.: 10/575,901

(22) PCT Filed: Oct. 14, 2004
(86) PCT No.: PCT/DE04/02283

§ 371 Date: Apr. 14, 2006

(30) Foreign Application Priority Data
Oct. 16, 2003 (DE) 203 15 935.7

(51) Int. Cl. B03C 3/00

(52) U.S. Cl. 96/15

(57) ABSTRACT

The invention relates to an electrostatic separator (1) for separating particles containing oil out of a gas stream, having an emission electrode (2) and a deposition electrode (3), wherein the emission electrode (2) has a front corona region (4) extending into the gas stream and a rear deposition region (5). An outlet opening (9) for separated oil running along the deposition electrode (3) is provided at the level of, or behind, the deposition region (5) of the emission electrode (2).

The invention relates to an electrostatic separator according to the preamble of claim 1.

Such electrostatic separators are known from the automotive field for separating oil from the gas stream of a crankcase ventilator in internal combustion engines.

During operation of the electrostatic separator, deposits can occur on the deposition electrode, which impermissibly reduce the spacing between the deposition electrode and the emission electrode. Proposals are known for cleaning deposits on electrostatic separators by means of moving parts.

The object of the invention is to improve an electrostatic separator of the generic type to the effect that it prevents the formation of deposits on the deposition electrode with the most economical and operationally reliable means possible.

This object is attained by an electrostatic separator with the features of claim 1.

In other words, the invention proposes to continuously flush the deposition electrode, specifically with the oil that has been separated from the gas stream or is yet to be removed from the electrostatic separator. The emission electrode is oriented with its corona region opposing the flow direction of the gas stream.

Designated within the framework of the present proposal as the corona region and, respectively, the deposition region, are one region each of the electrostatic separator in the flow direction of the gas stream. Located in the corona region is the portion of the emission electrode forming the corona, which charges or ionizes the particles, and where only a small fraction of the particles are already accumulated on the deposition electrode. The majority of the charged particles are accumulated on the deposition electrode in the adjacent deposition region.

Provided on the deposition electrode in this deposition region, or even further downstream in the direction of the gas stream, is an outlet opening through which the oil deposited on the deposition electrode can be drained.

Due to the proposed embodiment of the electrostatic separator, moving parts, which under certain circumstances may be prone to vibration, can be dispensed with.

In a first version, an inventive electrostatic separator can be provided with an upward-pointing corona region, hence be arranged within a downwardly-directed gas stream. In this case, the outlet opening for the oil is located correspondingly far down. The drainage of the oil at the deposition electrode is supported on the one hand by gravity and on the other hand by the gas stream. A reversal of direction of the air stream above the emission electrode effects a centrifugal-force-induced preliminary separation from the gas stream of the larger particles, in particular, which in this way arrive at the wall of the flow redirection chamber, whence they can flow down to the deposition electrode.

Especially advantageously, such a chamber can be embodied as a cyclone so that this chamber can serve as a true coarse separator or preseparator, and further separate coarse separators can be dispensed with. As a result, the installation of the electrostatic separator alone can be sufficient to allow an adequate cleaning of the gas stream, so that the use of an electrostatic separator embodied in such a manner makes possible considerable savings both with regard to the assembly as well as with regard to the installation space required, and finally also with regard to the quantity of material required, as compared to the use of an electrostatic separator which serves solely as a fine separator and works together with a separate coarse separator additionally connected upstream.

In a second version, with upward-flowing gas stream, the corona region of the emission electrode points downward in orientation. The gas stream must have a sufficiently high flow velocity for as large a quantity as possible of the oil deposited on the deposition electrode to be transported upward, where it can reach the outlet opening in order to return to the rest of the oil circulation through a separate outlet line. Here, too, a chamber for flow redirection of the gas stream is provided above the emission electrode, wherein the outlet opening for the separated oil is arranged between this chamber and the deposition electrode. In this chamber, a baffle can advantageously be provided, which causes the redirection of the gas stream, thus improving the degree of separation.

Two exemplary embodiments of the invention are explained in detail below on the basis of the two purely diagrammatic drawings.

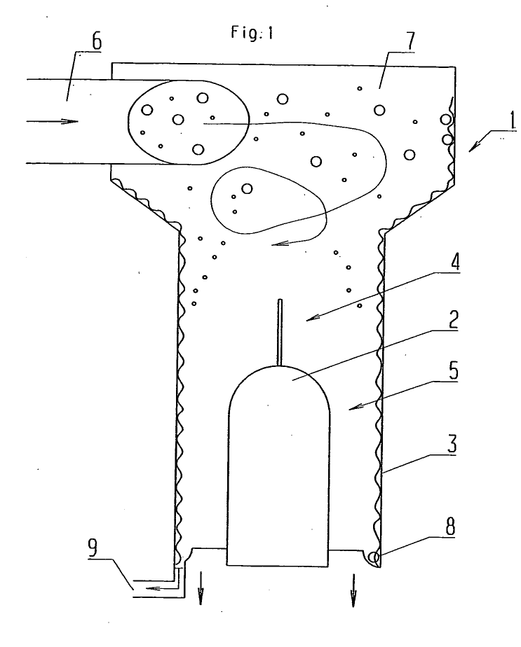

In FIG. 1, an electrostatic separator as a whole is diagrammatically labeled 1, which separator has an emission electrode 2 and a deposition electrode 3. The emission electrode 2 has a corona region 4 embodied to be needle-like, and also has a deposition region 5 with a diameter that is much larger in comparison thereto.

The gas stream is guided through the electrostatic separator 1 in that it first enters a chamber 7 through a gas inlet opening 6, wherein the gas inlet opening 6 is aligned such and the chamber 7 is designed such that a cyclone effect results and the coarser oil particles, in particular, are separated already in this chamber 7 onto the chamber walls thereof.

From the chamber 7, the wall transitions into the deposition electrode 3, so that the oil which was separated within the chamber runs along the deposition electrode 3, wets it, and in this way prevents the formation of deposits on the deposition electrode 3.

As the gas stream continues, it reaches the corona region 4, where the particles remaining in the gas stream are charged. In this way, the particles move to the deposition electrode 3, with this deposition collecting on the deposition electrode 3 especially in the section of the electrostatic separator 1 where the deposition region 5 of the emission electrode is located.

The entire volume of separated oil arrives at a collecting trough 8 at the bottom of the deposition electrode 3, from which trough an outlet opening 9 feeds the oil back into the oil circulation.

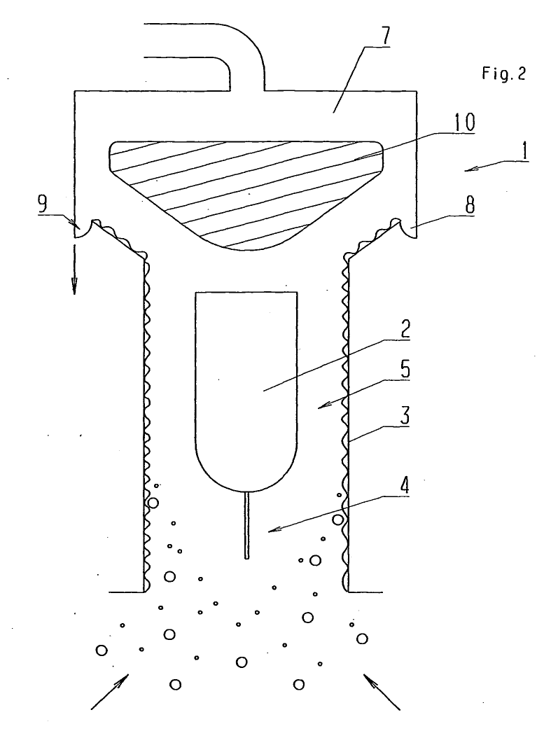

In FIG. 2, a second exemplary embodiment of the invention is shown in which essentially like components are labeled with the same reference numbers as in FIG. 1. In this second exemplary embodiment, however, the discharge electrode 2 is oriented downward, thus has a downward-pointing corona region 4, with the flow through this electrostatic separator 1 accordingly taking place from bottom to top. The oil particles located at the deposition electrode 3 are transported upward by the gas stream, yet without being entrained and entering the gas stream since they coagulate on the deposition electrode 3 and form correspondingly large particles or, respectively, an oil film on the deposition electrode 3.

Arranged in the chamber 7 for redirection of the gas stream, which is provided above the emission electrode 2 in this exemplary embodiment as well, is a baffle 10, which effects the change in direction and is flow-optimized, despite being called a baffle, since the gas stream is not directed against the baffle 10 for the separation of oil particles, but rather the baffle 10 is intended to divert the gas stream and direct it against the walls of the chamber 7 so that an additional after purification of the gas stream takes place here if needed.

The oil ascending along and being separated on the deposition electrode 3 arrives at a collecting trough 8, which is provided between the chamber 7 and the deposition electrode 3, wherein the oil is conveyed by this collecting trough 8 out of the electrostatic separator 1 through an outlet opening 9 and, for example, returned to the remaining oil circulation.

1. Electrostatic separator for separating particles containing oil out of a gas stream, having an emission electrode and a deposition electrode, wherein the emission electrode has a front corona region extending into the gas stream and a rear deposition region, characterized by an outlet opening (9) for separated oil running along the deposition electrode (3), wherein this outlet opening (9) is provided at the level of, or behind, the deposition region (5) of the emission electrode (2).

2. Electrostatic separator according to claim 1, characterized by an arrangement of the emission electrode (2) with an upward-pointing corona region (4), wherein provided above the emission electrode (2) is a chamber (7) for redirecting the gas stream, whose chamber walls adjoin the deposition electrode (3) such that oil located on the chamber walls flows downward along the deposition electrode (3) to the outlet opening (9).

3. Electrostatic separator according to claim 2, characterized in that a cyclone is provided above the emission electrode (2).

4. Electrostatic separator according to claim 1, characterized by an arrangement of the emission electrode (2) with a downward-pointing corona region (4), wherein a chamber (7) for redirecting the gas stream is provided above the emission electrode (2), and wherein the outlet opening (9) is arranged between the deposition electrode (3) and the chamber (7).

5. Electrostatic separator according to claim 4, characterized in that the chamber (7) contains a baffle (10).
